(19) United States
(12) Patent Application Publication
(10) Pub. No.: US 2015/0111113 A1
(43) Pub. Date: Apr. 23, 2015

(54) METAL-AIR BATTERY

(71) Applicant: HITACHI ZOSEN CORPORATION, Osaka (JP)

(72) Inventors: Kazuya Kameyama, Osaka (JP); Takehiro Shimizu, Osaka (JP); Masanobu Aizawa, Osaka (JP)

(73) Assignee: HITACHI ZOSEN CORPORATION, Osaka (JP)

(21) Appl. No.: 14/390,424

(22) PCT Filed: Apr. 3, 2013
(86) PCT No.: PCT/JP2013/002329

§ 371 Date: Oct. 3, 2014

(30) Foreign Application Priority Data
Apr. 17, 2012 (JP) P2012-093735

(51) Int. Cl. H01M 12/06; H01M 4/76

(52) U.S. Cl. CPC H01M 12/06; H01M 4/76
USPC 429/403

(57) ABSTRACT

A metal-air battery (1) includes a porous negative electrode (3) having a tubular shape and containing a metal, a porous positive electrode (2) having a tubular shape that surrounds the outer surface of the negative electrode (3), and an electrolyte layer (4) disposed between the negative electrode (3) and the positive electrode (2) and containing electrolyte solution. A filled part (31) enclosed by the inner surface of the negative electrode (3) is filled with electrolyte solution, and the electrolyte layer (4) is in communication with the filled part (31) via the porous negative electrode (3). The metal-air battery (1) further includes a supply-collection part (6) for collecting electrolyte solution in the filled part (31) and supplying electrolyte solution to the filled part (31). This facilitates replacement or the like of the electrolyte solution contained in the electrolyte layer (4).

### TECHNICAL FIELD

The present invention relates to a metal-air battery.

### BACKGROUND ART

Conventionally, metal-air batteries that each use a metal as an active material of the negative electrode and oxygen in the air as an active material of the positive electrode are known. For example, Japanese Patent Application Laid-Open No. 2011-129273 (Document 1) discloses an air battery that includes a columnar central shaft, a cylindrical electrolyte layer disposed around the shaft, a cylindrical negative electrode layer disposed around the electrolyte layer, another cylindrical electrolyte layer disposed around the negative electrode layer, a cylindrical air electrode layer disposed around the other electrolyte layer, and a cylindrical current collector layer disposed around the air electrode layer. Document 1 also describes that the shaft is formed in a hollow shape and is used as a space for holding an electrolyte solution.

Incidentally, in metal-air batteries, deterioration of electrolyte solution or the like leads to a drop in battery performance. In the air battery of Document 1, the hollow shaft is described as being used as a space for holding an electrolyte solution, but does not describe a technique for replacement or the like of the electrolyte solution. There is thus demand for a new technique that can facilitate replacement or the like of an electrolyte solution.

### SUMMARY OF INVENTION

The present invention is intended for a metal-air battery, and it is an object of the present invention to facilitate replacement or the like of an electrolyte solution in the metal-air battery.

The metal-air battery according to the present invention includes a porous negative electrode having a tubular shape and containing a metal, a porous positive electrode having a tubular shape that surrounds an outer surface of the negative electrode, an electrolyte layer disposed between the negative electrode and the positive electrode and containing electrolyte solution, and a supply-collection part for collecting electrolyte solution contained in a filled part enclosed by an inner surface of the negative electrode and supplying electrolyte solution to the filled part, the filled part being filled with electrolyte solution.

According to the present invention, replacement or the like of the electrolyte solution can be easily performed in the metal-air battery.

In a preferred embodiment of the present invention, the supply-collection part collects electrolyte solution contained in the filled part through one end of the negative electrode and supplies electrolyte solution to the filled part through the other end of the negative electrode. In this case, the supply-collection part may supply electrolyte solution collected through the one end, to the filled part through the other end. This enables the electrolyte solution to be reused.

In the above-described embodiment, it is preferable that the supply-collection part continuously performs collection of electrolyte solution contained in the filled part and supply of electrolyte solution to the filled part, and a flow velocity of electrolyte solution flowing in the filled part is adjustable. This enables the amount of air that is introduced into the positive electrode to be adjusted.

In another preferred embodiment of the present invention, the electrolyte layer includes a tubular porous member, and the tubular porous member is filled with electrolyte solution.

These and other objects, features, aspects and advantages of the present invention will become more apparent from the following detailed description of the present invention when taken in conjunction with the accompanying drawings.

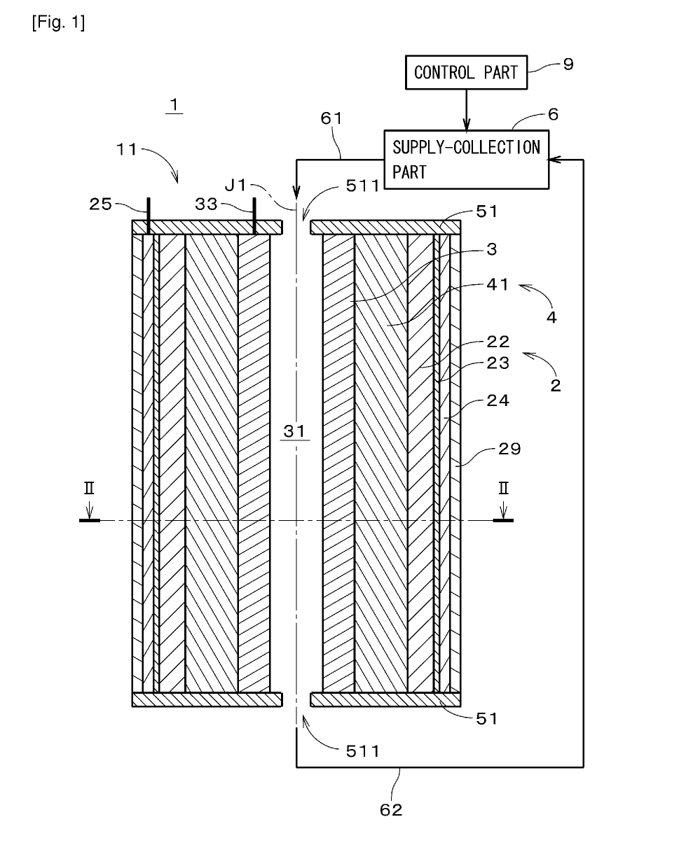

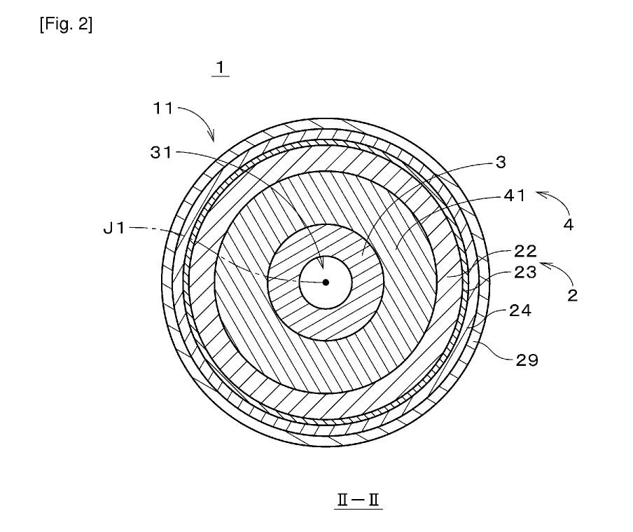

### BRIEF DESCRIPTION OF DRAWINGS

[FIG. 1] FIG. 1 illustrates a configuration of a metal-air battery.

[FIG. 2] FIG. 2 is a transverse cross-sectional view of a main body of the metal-air battery.

### DESCRIPTION OF EMBODIMENTS

FIG. 1 illustrates a configuration of a metal-air battery 1 according to an embodiment of the present invention. A main body 11 of the metal-air battery 1 has a generally cylindrical shape centered on a central axis J1. In FIG. 1, a cross section of the main body 11 including the central axis J1 is illustrated. FIG. 2 is a transverse cross-sectional view of the main body 11 of the metal-air battery 1, taken along II-II in FIG. 1. As illustrated in FIGS. 1 and 2, the metal-air battery 1 is a secondary battery that includes a positive electrode 2, a negative electrode 3, and an electrolyte layer 4. The negative electrode 3, the electrolyte layer 4, and the positive electrode 2 are concentrically disposed in the stated order, radially outward from the central axis J1.

The negative electrode 3 (also referred to as a “metal electrode”) is a tubular porous member centered on the central axis J1 and is formed from a metal such as magnesium (Mg), aluminum (Al), zinc (Zn), or iron (Fe) or an alloy containing any of these metals. In the present embodiment, the negative electrode 3 is formed of zinc in a cylindrical shape having an outer diameter of 11 millimeters (mm) and an inner diameter of 5 mm. As illustrated in FIG. 1, the negative electrode 3 has a negative electrode current collector terminal 33 connected to one end in the direction of the central axis J1. As illustrated in FIGS. 1 and 2, a space 31 surrounded by the inner surface of the negative electrode 3 (hereinafter, referred to as a “filled part 31”) is filled with an aqueous electrolyte solution (also called “electrolyte”).

The electrolyte layer 4 surrounding the negative electrode 3 is disposed on the outer side of the negative electrode 3. The electrolyte layer 4 includes a tubular porous member 41, the inner surface of which faces the outer surface of the negative electrode 3. The electrolyte layer 4 is in communication with the filled part 31 through the pores of the porous negative electrode 3, and the porous member 41 is also filled with the electrolyte solution. The porous member 41 is formed from a ceramic, a metal, an inorganic material, an organic material, or the like and is preferably a sintered ceramic (i.e., an integrally molded ceramic) having high insulating properties, such as alumina, zirconia, or hafnia. From the viewpoint of preventing an increase in the distance between the negative electrode 3 and the later-described positive electrode 2 while securing a certain degree of mechanical strength, it is preferable for the porous member 41 to have a thickness that is greater than or equal to 0.5 mm and is less than or equal to 4 mm. The electrolyte solution in the present embodiment is a high-concentration aqueous alkaline solution (e.g., 8 mol/L (M) aqueous potassium hydroxide (KOH) solution) that is saturated with zinc oxide. Alternatively, the electrolyte solution may be another aqueous electrolyte solution or a non-aqueous (e.g., organic solvent) electrolyte solution.

The positive electrode 2 (also referred to as an “air electrode”) includes a porous positive electrode conductive layer 22. The positive electrode conductive layer 22 is formed (laminated) in a tubular shape on the outer surface of the porous member 41 of the electrolyte layer 4. A positive electrode catalyst is supported on the outer surface of the positive electrode conductive layer 22, thus forming a positive electrode catalyst layer 23. A mesh sheet of metal such as nickel, for example, is wound around the positive electrode catalyst layer 23, forming a current collector layer 24. The current collector layer 24 has a positive electrode current collector terminal 25 connected to one end in the direction of the central axis J1. In actuality, the positive electrode catalyst is dispersed in the vicinity of the outer surface of the positive electrode conductive layer 22 and is not formed as a definite layer. Thus, the current collector layer 24 is also partially in contact with the outer surface of the positive electrode conductive layer 22. Alternatively, an interconnector that is in contact with only part of the outer surface of the positive electrode conductive layer 22 may be provided as the current collector layer 24.

On the outer surface of the current collector layer 24 (including portions of the outer surface of the positive electrode catalyst layer 23 that are not covered with the mesh current collector layer 24), a porous layer made of a material having water repellency (e.g., perfluoroalkoxy alkane (PFA) or polytetrafluoroethylene (PTFE)) is formed as a liquid-repellent layer 29. The liquid-repellent layer 29 is formed using, for example, a slurry coating process followed by firing.

From the viewpoint of preventing deterioration due to oxidation during charging described later, it is preferable for the positive electrode conductive layer 22 not to contain carbon. In the present embodiment, the positive electrode conductive layer 22 is a thin porous conductive film formed primarily of a perovskite type oxide having electrical conductivity (e.g., LSMF (LaSrMnFeO₃)). This positive electrode conductive layer 22 is formed by first coating a perovskite type oxide on the outer surface of the porous member 41 using a slurry coating process and then subjecting the whole to firing. Alternatively, the above positive electrode conductive layer 22 may be formed with other methods including a hydrothermal synthesis method, chemical vapor deposition (CVD), and physical vapor deposition (PVD).

The positive electrode catalyst layer 23 is formed from a catalyst that accelerates oxygen reduction reactions. Examples of the catalyst include oxides of metals such as manganese (Mn), nickel (Ni), and cobalt (Co). In the present embodiment, the positive electrode catalyst layer 23 is formed from manganese dioxide (MnO₂) that is preferentially supported by the positive electrode conductive layer 22, using a hydrothermal synthesis method. Alternatively, the positive electrode catalyst layer 23 may be formed with other methods such as a slurry coating method followed by firing, CVD, and PVD. In the metal-air battery 1, in principle, an interface between the air and the electrolyte solution is formed in the vicinity of the porous positive electrode catalyst layer 23.

As illustrated in FIG. 1, disk-shaped closure members 51 are fixed to opposite end faces (top and bottom end faces in FIG. 1) of the negative electrode 3, the electrolyte layer 4, and the positive electrode 2 in the direction of the central axis J1. The closure members 51 each have a through hole 511 formed in the center, and the through holes 511 open into the filled part 31. In the metal-air battery 1, the liquid-repellent layer 29 and the closure members 51 serve to prevent the electrolyte solution in the main body 11 from leaking out to the outside other than through the through holes 511.

One end of a supply pipe 61 is connected to the through hole 511 of one of the closure members 51, and the other end of the supply pipe 61 is connected to a supply-collection part 6. One end of a collection pipe 62 is connected to the through hole 511 of the other closure member 51, and the other end of the collection pipe 62 is connected to the supply-collection part 6. The supply-collection part 6 includes a pump and a reservoir tank for storing an electrolyte solution, and is capable of collecting electrolyte solution contained in the filled part 31 into the reservoir tank at a flow rate (volume per unit time) instructed by a control part 9 and supplying electrolyte solution in the reservoir tank to the filled part 31 at the same flow rate. In other words, electrolyte solution can be circulated between the filled part 31 and the reservoir tank of the supply-collection part 6. The supply-collection part 6 is provided with a filter, and during circulation of electrolyte solution, unwanted materials contained in the electrolyte solution are removed with the filter.

In the metal-air battery 1 of the present embodiment, the central axis J1 of the main body 11 is parallel to the vertical direction (direction of gravity), and the through hole 511 connected to the collection pipe 62 is located lower in the vertical direction than the through hole 511 connected to the supply pipe 61. The supply pipe 61 and the collection pipe 62 are provided respectively with a supply valve and a collection valve (not shown). In the present exemplary operation, the electrolyte solution is circulated at a constant flow velocity during normal operation. Note that the supply valve and the collection valve can be taken as part of the supply-collection part 6.

When the metal-air battery 1 in FIG. 1 is discharged, the negative electrode current collector terminal 33 and the positive electrode current collector terminal 25 are electrically connected to each other via a load (e.g., lighting fitting). The metal contained in the negative electrode 3 is oxidized into metal ions (here, zinc ions (Zn²⁺)), and electrons are supplied to the positive electrode 2 through the negative electrode current collector terminal 33, the positive electrode current collector terminal 25, and the current collector layer 24. In the porous positive electrode 2, oxygen in the air that has permeated the liquid-repellent layer 29 is reduced by the electrons supplied from the negative electrode 3 into hydroxide ions (OH⁻) in the case where the aqueous electrolyte solution is used. In the positive electrode 2, since the generation of hydroxide ions (i.e., reduction reaction of oxygen) is accelerated by the positive electrode catalyst, overvoltage due to the energy consumed in the reduction reaction decreases, and accordingly the discharge voltage of the metal-air battery 1 can be increased. In actuality, zinc oxide ions are eluted in the electrolyte solution.

On the other hand, when the metal-air battery 1 is charged, a voltage is applied between the negative electrode current collector terminal 33 and the positive electrode current collector terminal 25. In the positive electrode 2, electrons are supplied from the hydroxide ions to the positive electrode current collector terminal 25 through the current collector layer 24, and oxygen is produced. In the negative electrode 3, metals ions are reduced by the electrons supplied to the negative electrode current collector terminal 33, and a metal is deposited on the surface (outer surface). In the positive electrode 2, since the production of oxygen is accelerated by the positive electrode catalyst contained in the positive electrode catalyst layer 23, overvoltage decreases, and the charge voltage of the metal-air battery 1 can be reduced.

As described previously, in the metal-air battery 1, the electrolyte solution is circulated by the supply-collection part 6, and the electrolyte solution (mostly electrolyte solution contained in the filled part 31 but includes some electrolyte solution contained in the negative electrode 3 and the electrolyte layer 4) in the vicinity of the through hole 511 that is located lower (hereinafter, also referred to as the “lower through hole 511”) is collected through the lower through hole 511. Part of the electrolyte solution supplied to the filled part 31 through the through hole 511 that is located upper (hereinafter, also referred to as the “upper through hole 511”) is also diffused in the electrolyte layer 4 (porous member 41) through the pores of the negative electrode 3. In this way, the electrolyte solution supplied from the supply-collection part 6 is also mixed into the electrolyte layer 4. Through this, the electrolyte solution contained in the electrolyte layer 4 is slowly replaced by the electrolyte solution in the reservoir tank of the supply-collection part 6 while the metal-air battery 1 is being discharged or charged. Furthermore, because the electrolyte solution in the vicinity of the outer surface of the negative electrode 3 is agitated, concentration polarization of eluted zinc oxide ions can be reduced during discharge, and therefore it is possible to suppress a drop in battery performance due to generation of a passive film on the negative electrode 3. Note that it is preferable for the electrolyte solution in the reservoir tank of the supply-collection part 6 to be saturated with zinc oxide. It is also preferable that, in the reservoir tank, the electrolyte solution is heated to a temperature in a range from room temperature to approximately 70 degrees C.

In the metal-air battery 1, the sequential operation of collecting a predetermined amount of electrolyte solution through the lower through hole 511 and supplying the same amount of electrolyte solution through the upper through hole 511 may be repeatedly performed. Through this, the electrolyte solution contained in the electrolyte layer 4 is replaced by the electrolyte solution in the reservoir tank of the supply-collection part 6 while the metal-air battery 1 is being charged or discharged. Alternatively, the replacement of electrolyte solution may be intermittently performed. For example, the supply valve and the collection valve may be closed after the electrolyte solution is circulated for a predetermined period of time, so that the collection and supply of the electrolyte solution are stopped until the newly diffused electrolyte solution achieves an equilibrium state. Through this, the replacement of electrolyte solution in the main body 11 (mixture of deteriorated electrolyte solution and fresh electrolyte solution) is performed while the metal-air battery 1 is being charged or discharged. It is, of course, possible to perform the replacement of electrolyte solution in the main body 11 after suspending discharging or charging.

During maintenance of the metal-air battery 1, it is also possible to clean the inner surface of the negative electrode 3 by introducing air bubbles through the lower through hole 511 and the collection pipe 62 while reversing the flow of the electrolyte solution (i.e., causing the electrolyte solution to flow from the lower through hole 511 side to the upper through hole 511 side).

As described above, in the metal-air battery 1, the filled part 31 surrounded by the inner surface of the tubular negative electrode 3 is filled with the electrolyte solution, and the electrolyte layer 4 disposed between the negative electrode 3 and the tubular positive electrode 2 surrounding the outer surface of the negative electrode 3 is in communication with the filled part 31 via the porous negative electrode 3. By the supply-collection part 6 performing collection of the electrolyte solution contained in the filled part 31 and supply of the electrolyte solution to the filled part 31, the replacement of electrolyte solution in the electrolyte layer 4 can be easily performed.

In the metal-air battery 1, because the electrolyte layer 4 includes the tubular porous member 41 and the tubular porous member 41 is filled with the electrolyte solution, it is possible, when a metal is deposited dendritically on the negative electrode 3 during charging, to suppress the growth of dendritically deposited portions (so-called dendrites) toward the positive electrode 2. Here, if a porous member is configured by combining a large number of fine particles with a binder, there is a risk that dendrites will grow through binder portions. However, in the present embodiment, the porous member 41 that serves as a separator is a sintered ceramic that does not include a binder, and therefore it is possible to more reliably suppress the growth of dendrites toward the positive electrode 2. Consequently, it is possible to prevent a situation in which dendrites reach the positive electrode 2 and cause a short circuit. Moreover, in the metal-air battery 1, because the porous member 41 also serves as a support of the positive electrode 2, the weight and manufacturing cost of the metal-air battery 1 can be reduced.

By forming the positive electrode 2 on the outer surface (including the inside of the pores) of the porous member 41 as well as disposing the positive electrode 2 on the outer circumferential side of the negative electrode 3, it is possible to secure a large surface area for reactions and to improve battery performance. Furthermore, the positive electrode 2 disposed on the outer peripheral side can efficiently diffuse oxygen produced during charging to the outside and thus can achieve high energy density even in the case of using an electrolyte solution having a low amount of saturated-dissolved oxygen.

Next is a description of another exemplary operation performed by the metal-air battery 1. Also in this exemplary operation, the supply-collection part 6 continuously performs collection of the electrolyte solution contained in the filled part 31 and supply of the electrolyte solution to the filled part 31 during normal operation. That is, electrolyte solution is always circulated (in principle). Furthermore, the flow velocity of the electrolyte solution flowing through the filled part 31 during discharge is set higher than the flow velocity during charging, by the control part 9 controlling, for example, the degree of openings of the valves and the pump of the supply-collection part 6. In the main body 11, because the pressure of the electrolyte solution in the main body 11 decreases in accordance with an increase in the flow velocity of the electrolyte solution in the filled part 31 (Venturi effect), the amount of air introduced into the positive electrode 2 (the amount of air introduced per unit time) during discharge increases, and discharge of the metal-air battery 1 is efficiently performed. During charging, because the flow velocity of the electrolyte solution flowing in the filled part 31 is lower than the flow velocity during discharge, the release of oxygen from the positive electrode 2 is not inhibited.

As described above, the supply-collection part 6 is capable of adjusting the flow velocity of the electrolyte solution flowing in the filled part 31, enabling the amount of air that is introduced into the positive electrode 2 to be adjusted. Discharging and charging of the metal-air battery 1 can thus be efficiently performed. Furthermore, by the supply-collection part 6 supplying the electrolyte solution collected through one end of the negative electrode 3, to the filled part 31 through the other end of the negative electrode 3, the electrolyte solution can be reused after processes such as removal of unwanted materials from the electrolyte solution with the filter provided in the supply-collection part 6. Note that the concentration of zinc in the electrolyte solution may be adjusted in the reservoir tank of the supply-collection part 6.

Incidentally, although it is conceivable to provide the closure members 51 with through holes that are in communication with the electrolyte layer 4, it is not easy to adopt a structure in which electrolyte solution is circulated using the thin electrolyte layer 4 as part of a circulation path. It is also difficult to appropriately realize a discharge reaction while increasing the amount of air that is introduced due to the Venturi effect as described above. Furthermore, circulating electrolyte solution is particularly difficult when the electrolyte layer 4 includes the porous member 41. In contrast, the metal-air battery 1 uses the filled part 31 surrounded by the inner surface of the negative electrode 3 as part of the circulation path and thus can easily circulate electrolyte solution.

While the above has been a description of an embodiment of the present invention, the present invention is not intended to be limited to the above-described embodiment, and various modifications are possible.

In the metal-air battery 1, it is not absolutely necessary to circulate the electrolyte solution, and a configuration is possible in which a collection part for collecting the electrolyte solution in the filled part 31 and a supply part for supplying the electrolyte solution to the filled part 31 are independently provided in the supply-collection part 6.

In the metal-air battery 1 in FIG. 1, the replacement or the like of the electrolyte solution can be easily performed by the supply-collection part 6 performing collection of electrolyte solution contained in the filled part 31 through one end of the negative electrode 3 in the direction of the central axis J1 and supply of electrolyte solution to the filled part 31 through the other end of the negative electrode 3, using the aforementioned various techniques. Alternatively, depending on the design of the metal-air battery 1, a through hole 511 may be provided at only one end of the negative electrode 3. In this case, this through hole 511 is connected to the supply-collection part 6, and collection of electrolyte solution in the filled part 31 and supply of electrolyte solution to the filled part 31 are alternately performed.

The negative electrode 3 may be provided if necessary with communication pores (pores larger than the pores of the negative electrode 3) that communicate the filled part 31 with the electrolyte layer 4. If the occurrence of dendrites is not a problem, the porous member 41 serving as a separator may be omitted from the electrolyte layer 4.

The main body 11 of the metal-air battery 1 can be of any kind of tubular shape, and may be a polygonal tubular shape other than a cylindrical shape. The central axis J1 of the metal-air battery 1 does not necessarily have to be parallel to the vertical direction, and for example, the metal-air battery 1 may be disposed such that the central axis J1 is parallel to the horizontal direction. A configuration is also possible in which a plurality of main bodies 11 are provided and a single supply-collection part 6 is connected to these main bodies 11.

The configurations of the above-described embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

1 Metal-air battery

2 Positive electrode

3 Negative electrode

4 Electrolyte layer

6 Supply-collection part

31 Filled part

41 Porous member

J1 Central axis

1. A metal-air battery comprising:
a porous negative electrode having a tubular shape and containing a metal;
a porous positive electrode having a tubular shape that surrounds an outer surface of said negative electrode;
an electrolyte layer disposed between said negative electrode and said positive electrode and containing electrolyte solution; and
a supply-collection part for collecting electrolyte solution contained in a filled part enclosed by an inner surface of said negative electrode and supplying electrolyte solution to said filled part, said filled part being filled with electrolyte solution, wherein
said electrolyte layer includes a tubular porous member, and
said tubular porous member is filled with electrolyte solution.

2. The metal-air battery according to claim 1, wherein
said supply-collection part collects electrolyte solution contained in said filled part through one end of said negative electrode and supplies electrolyte solution to said filled part through the other end of said negative electrode.

3. The metal-air battery according to claim 2, wherein
said supply-collection part supplies electrolyte solution collected through said one end, to said filled part through said other end.

4. The metal-air battery according to claim 2, wherein
said supply-collection part continuously performs collection of electrolyte solution contained in said filled part and supply of electrolyte solution to said filled part, and
a flow velocity of electrolyte solution flowing in said filled part is adjustable.

5. (canceled)

6. The metal-air battery according to claim 3, wherein
said supply-collection part continuously performs collection of electrolyte solution contained in said filled part and supply of electrolyte solution to said filled part, and
a flow velocity of electrolyte solution flowing in said filled part is adjustable.
